(19) United States
(12) Patent Application Publication
(10) Pub. No.: US 2022/0324407 A1
(43) Pub. Date: Oct. 13, 2022

(54) Trim Assembly

(71) Applicant: Volvo Car Corporation, Göteborg (SE)

(72) Inventors: Magnus S. BERGMAN, Göteborg (SE); Daniel WIESLANDER, Göteborg (SE); Jonas ODHNER, Göteborg (SE)

(21) Appl. No.: 17/694,873

(22) Filed: Mar. 15, 2022

(30) Foreign Application Priority Data
Apr. 9, 2021 (EP) 21167646.5

(51) Int. Cl. B60R 21/213; B60R 21/232

(52) U.S. Cl. CPC B60R 21/213; B60R 21/232; B60R 2021/161

(57) ABSTRACT

A trim assembly for deploying an airbag element, a vehicle including such a trim assembly and a method for manufacturing such a trim assembly. The trim unit includes a vehicle body portion, a trim unit and at least one fixing element. The fixing element is configured to attach the trim unit to the vehicle body portion. The airbag element is arranged between the trim unit and the vehicle body portion. The trim unit is configured to cover at least partially the airbag element. The trim unit is pivotable about the fixing element such that the trim unit is tilted away from the vehicle body portion during a deployment of the airbag element.

### CROSS-REFERENCE TO RELATED APPLICATION

The present disclosure claims the benefit of priority of co-pending European Patent Application No. 21 167 646.5, filed on Apr. 9, 2021, and entitled “TRIM ASSEMBLY,” the contents of which are incorporated in full by reference herein.

### TECHNICAL FIELD

The present disclosure relates to a trim assembly for deploying an airbag element, a vehicle including such a trim assembly and a method for manufacturing such a trim assembly.

### BACKGROUND

An airbag system is a safety device for occupants to minimize injury caused by directly striking between the occupants and a vehicle structure in case of a vehicle collision. In general, the airbag system includes an airbag arranged between a trim and a vehicle body, which can be opened to provide a gap between the trim and the vehicle body for releasing and inflating the airbag. Conventionally, the trim is fastened to the vehicle body by means of a screw joint.

### SUMMARY

There still may be a need to provide an improved trim, which facilitates a more safe operation of an airbag system.

The problem is solved by the subject matter of the independent claims of the present disclosure, wherein further embodiments are incorporated in the dependent claims. It should be noted that the aspects of the disclosure described in the following apply to the trim assembly for deploying an airbag element, a vehicle including such a trim assembly and a method for manufacturing such a trim assembly.

According to the present disclosure, a trim assembly for deploying an airbag element is presented. The trim assembly includes a vehicle body portion, a trim unit and at least one fixing element. The fixing element is configured to attach the trim unit to the vehicle body portion. The airbag element is arranged between the trim unit and the vehicle body portion. The trim unit is configured to cover at least partially the airbag element. The trim unit is pivotable about the fixing element such that the trim unit is tilted away from the vehicle body portion during a deployment of the airbag element.

The trim assembly according to the present disclosure allows a safe operation of the airbag element. During a deployment of the airbag element, in particular, the trim unit generally causes cracks and/or fragments due to its rigid attachment to the vehicle body portion by a screw. The fixing element according to the present disclosure, however, ensures a movement of the trim unit by pivoting the trim unit about the fixing element. Hence, a gap between the vehicle body portion and the trim unit may be provided if the airbag element is deployed. Accordingly, a controlled opening of the trim unit may be realized, which may minimize or even avoid cracks and/or fragments of the trim unit. Furthermore, the fixing element allows an easy mounting of the trim unit and the trim unit may be not separated from the vehicle body portion even though the airbag element deploys.

The vehicle body portion may be a front portion, a side portion and/or a back portion of a body frame of the vehicle. The vehicle body portion may also extend from the front side to the rear side along the body frame of the vehicle. The vehicle body portion may be directed inside a compartment of the vehicle or outside of the vehicle.

An airbag unit may include at least a coupling element and the airbag element. In an initial mounting state, the airbag element may be compactly folded or compressed to facilitate an assembly and save space. The coupling element of the airbag unit may be configured to fixedly connect the airbag element at the vehicle body portion such that the airbag element may not become loose if the airbag element is inflated.

The trim unit may be configured to cover or case at least the airbag element, preferably the whole airbag unit such that the airbag unit may not be exposed to an environment if the airbag is not in use. To mount the trim unit to the vehicle body portion, but also to cover the airbag element at least partially, preferably completely, the trim unit may include a recess or a groove extending in a longitudinal direction of the trim unit. A cross-section of the trim unit may be adapted to fit to a shape of the vehicle body portion.

The fixing element may be arranged at the trim unit or the vehicle body portion to attach the trim unit to the vehicle body portion. Alternatively, the fixing element may be inserted into the vehicle body portion through the trim unit. Accordingly, the trim unit may be fixedly held at the vehicle body portion by the fixing element even though the airbag element deploys out between the vehicle body portion and the trim unit. The trim assembly may include at least one fixing element, but also a plurality of the fixing elements arranged along the longitudinal direction of the trim unit. The fixing element may be a screw, a shoulder screw, a clamping element or the like.

The fixing element may be arranged between the trim unit and the vehicle body portion such that the trim unit may be swing around the fixing element to provide a gap between the trim unit and the vehicle body portion in case of a deployment of the airbag element. In other words, the trim unit may be pushed or tiled away from the vehicle body portion while the fixing element holds the trim unit to prevent from a complete separation of the trim unit. The term “tilted” may be understood so that an angle between the trim unit and the vehicle body portion may be arisen by opening the trim unit around the fixing element. Accordingly, the airbag element may be inflated without any damage on the trim unit, since the trim unit is still connected to the vehicle body portion.

In an embodiment, the trim unit includes at least one guiding portion, which is formed as a through-hole and configured to receive the fixing element. The trim unit may be formed to receive the fixing element connecting the trim unit and the vehicle body portion. Accordingly, the trim unit may include the guiding portion, which may be cylindrically formed through the trim unit, so that the guiding portion may extend in the direction of the vehicle body portion and receive the fixing element therein. However, a cross-section of the guiding portion may not be limited to a circle, but also it may be formed as rectangular, polygonal or the like. The trim unit may include at least one guiding portion, but also a plurality of guiding portions with respect to a number of fixing element applied.

In an embodiment, the guiding portion includes a protrusion formed at least partially at an inner surface of the through-hole. The protrusion is configured to hold the fixing element in place. In other words, the guiding portion may include a protrusion on the inner surface of the guiding portion. The protrusion may at least partially or completely project from the inner surface of the guiding portion and at least partially or completely extend along a circumferential direction of the inner surface of the guiding portion. The protrusion may be also arranged spirally along the circumferential direction of the inner surface of the guiding portion.

When the fixing element is inserted into the guiding portion, the protrusion may hold a part of the fixing element such that the fixing element is not arranged to deep or high in the guiding portion. Accordingly, the fixing element may support the fixing element to be positioned correctly, which ensures a reliable pivoting movement of the trim unit around the fixing element without any damage.

In an embodiment, the fixing element includes a head portion, a shoulder portion and a threaded portion. The shoulder portion connects the head portion and the threaded portion and the shoulder portion has a bigger diameter than the threaded portion. Further, only the threaded portion is screwed in the vehicle body portion through the trim unit.

In other words, the fixing element may be a shoulder screw. The shoulder screw may be divided by the head portion, the shoulder portion and the threaded portion. The threaded portion may include a thread with a diameter smaller than the shoulder portion. The shoulder portion may be formed as a cylinder such that the shoulder portion does not include any thread. Accordingly, if the fixing element is inserted into the guiding portion of the trim unit, only the threaded portion of the fixing element may be screwed in the vehicle body portion through the trim unit to fasten the trim unit to the vehicle body portion.

In an embodiment, the head portion has a bigger diameter than the shoulder portion and the head portion is held by the protrusion of the guiding portion. The head portion may be formed cylindrically. Alternatively or additionally, the head portion may include a flange. In both cases, an outer diameter of the head portion is bigger than the diameter of the shoulder portion. Accordingly, only the shoulder portion may be pass through the protrusion and the head portion may be supported by the protrusion.

In an embodiment, a width of the protrusion measuring from the inner surface in direction to a center of the guiding portion may be configured so that at least a part of the protrusion may escape from the head portion when pivoting the trim unit.

In an embodiment, the shoulder portion defines a distance between the vehicle body portion and the protrusion of the guiding portion. Since only the threaded portion of the fixing element may be screwed in the vehicle body portion and the head portion may be arranged at the protrusion of the guiding portion, the shoulder portion may be disposed between the vehicle body portion and the protrusion. Accordingly, a length of the shoulder portion may correspond to the distance between the vehicle body portion and the protrusion of the guiding portion.

In an embodiment, the trim unit is pivotable around the shoulder portion of the fixing element. The trim unit may be pivotable, for example, until a bottom surface of the guiding portion reaches the head portion of the fixing unit. In other words, the guiding portion may be movable within the length of the shoulder portion during pivoting of the trim unit. Still in other words, the bottom surface of the guiding portion may be held by the shoulder portion of the fixing element. Accordingly, the trim unit may not be separated from the vehicle body portion even though the airbag element is deployed, hence, a secure opining of the trim unit may be achieved.

In an embodiment, the guiding portion is arranged on an opposite side relative to a deployment direction of the airbag element. To effectively deploy the airbag element, the guiding portion, accordingly the fixing element, may be arranged in an opposite direction relative to the opening direction of the trim unit or the deployment direction of the airbag element. Thus, a deployment of the airbag element may not be interfered by the guiding portion or the fixing element.

In an embodiment, the trim unit further includes at least one clamping element. The clamping element may support a safe and firm attachment of the trim unit to the vehicle body portion. In contrast to the fixing element, however, the clamping element may be lose when the airbag element is deployed. The trim unit may also include a plurality of clamping elements.

In an embodiment, the trim unit is an A-pillar, B-pillar, C-pillar and/or D-pillar and the airbag element includes an inflatable curtain. In other words, the trim unit may be arranged where the airbag element is attached to the vehicle body portion in a compressed form. The inflatable curtain may be deployed particularly along doors or side windows of the vehicle to protect occupants during a side impact or a rollover situation. Since the trim unit neither separates from the vehicle body portion nor breaks due to a pivoting movement of the trim unit, a safe operation of the inflatable curtain may be ensured.

In an embodiment, a pivoting angle of the trim unit is adaptable to a shape of the vehicle body portion. According to a position in which the trim unit and the airbag element are arranged, the trim unit may be differently pivoted or opened to avoid straining the trim unit and the fixing element. The pivoting angle may be adjusted, for example, by the length of the shoulder portion of the fixing element.

According to the present disclosure, also a vehicle is presented. The vehicle includes the trim assembly as described above. Accordingly, the vehicle allows a safe deployment of the airbag element.

According to the present disclosure, also a method for manufacturing a trim assembly is presented. The method includes the steps of, but not necessarily in this order:
attaching a trim unit to a vehicle body portion,
arranging an airbag element between the trim unit and the vehicle body portion,
covering the airbag element at least partially by the trim unit, so that during a deployment of the airbag element, the trim unit being pivotable about the fixing element such that the trim unit being tilted away from the vehicle body portion.

It should be noted that the above embodiments may be combined with each other irrespective of the aspect involved. Accordingly, the method may be combined with structural features and, likewise, the system may be combined with features described above with regard to the method.

These and other aspects of the present disclosure will become apparent from and elucidated with reference to the embodiments described hereinafter.

### BRIEF DESCRIPTION OF THE DRAWINGS

Exemplary embodiments of the disclosure will be described in the following with reference to the following drawings.

FIG. 1A and FIG. 1B show schematically and exemplarily a conventional trim assembly.

FIG. 2 shows schematically and exemplarily an embodiment of a trim assembly according to the present disclosure.

FIG. 3A and FIG. 3B show schematically and exemplarily an embodiment of a trim assembly according to the present disclosure.

### DESCRIPTION OF EMBODIMENTS

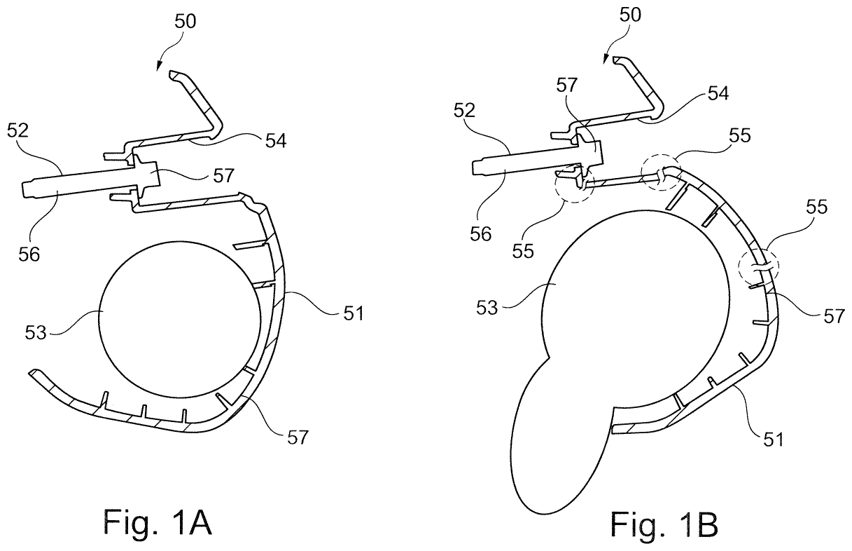

FIG. 1A and FIG. 1B show a conventional trim assembly 50, which may be arranged in a vehicle. FIG. 1A shows the trim assembly 50 in an initial mounting position. The trim assembly 50 includes a trim unit 51 attached to a vehicle body portion (not shown) by means of a fixing element 52 such as a screw. The trim unit 51 includes a through-hole 54 to receive the screw 52. Generally, a shaft 56 of the screw 52 is completely inserted into the vehicle body portion to mount the trim unit 51 to the vehicle body portion, whereas the head 57 of the screw 52 is arranged directly at a bottom of the through-hole 54. An airbag element 53 is arranged between the vehicle body portion and the trim unit 51.

FIG. 1B shows the trim assembly 50 in case of a deployment of the airbag element 53 caused, for example, by a vehicle collision. To allow the airbag element 53 to inflate, the trim unit 51 is opened such that a gap between the vehicle body portion and the trim unit 51 may be provided. In the conventional trim assembly 50, however, the trim unit 51 is fixedly held by the screw head 57. Hence, only a covering portion 58 of the trim unit 51 surrounding the airbag element 53 may be pressed outwardly in an opposite direction relative to the vehicle body portion to provide the gap. This would cause cracks 55 or fragments of weak areas of the trim unit 51. The cracks or fragments occur even more severely in a very cold condition at several minus degrees.

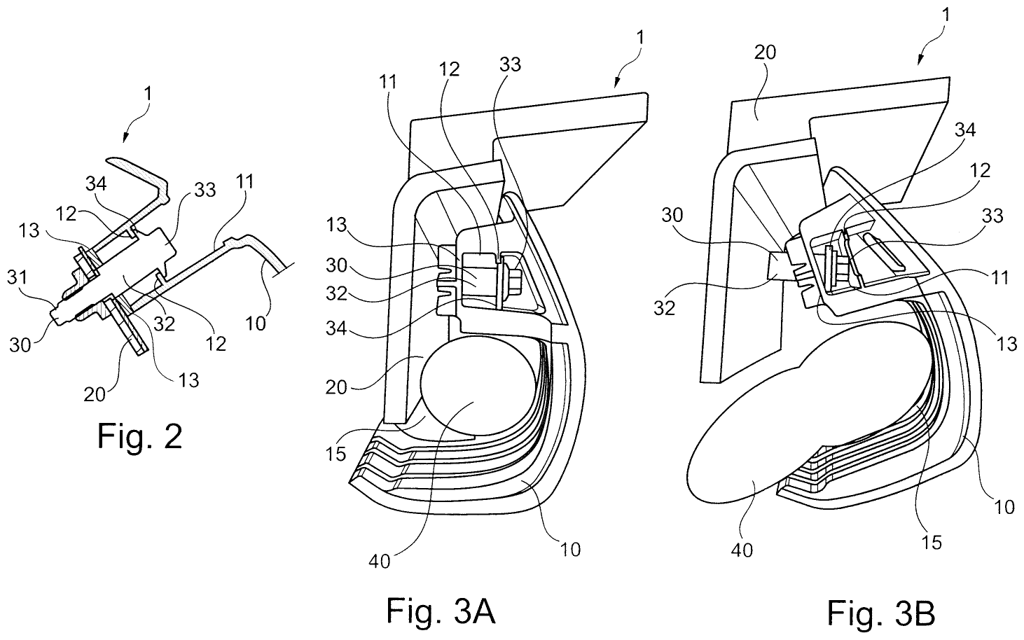

FIG. 2 shows a trim assembly 1 for deploying an airbag element 40 according to the present disclosure. The trim assembly 1 may be arranged in a vehicle and the trim unit 10 may be an A-, B-, C- and/or D-pillar. The airbag element 40 may be an inflatable curtain.

The trim assembly 1 includes a vehicle body portion 20, a trim unit 10 and at least one fixing element 30. The fixing element 30 (see also FIGS. 3A and 3B) may be a shoulder screw including a threaded portion 31, a shoulder portion 32 and a head portion 33, wherein the shoulder portion 32 connects the threaded portion 31 and the head portion 33. The fixing element 30 is configured to attach the trim unit 10 to the vehicle body portion 20. The airbag element 40 is arranged between the trim unit 10 and the vehicle body portion 20. The trim unit 10 includes a covering portion 15 formed as a recess or groove extending along a longitudinal direction of the trim unit 10 to cover at least partially, preferably completely the airbag element 40.

The trim unit 10 further includes at least one guiding portion 11 formed as a through-hole to receive the fixing element 30 for connecting the trim unit 10 and the vehicle body portion 20. However, the trim unit 10 may also include a plurality of the guiding portions 11 along the longitudinal direction of the trim unit 10 such that a plurality of the fixing elements 30 may attach the trim unit 10 to the vehicle body portion 20. The guiding portion 11 is arranged on an opposite side relative to a deployment direction of the airbag element 40 to avoid interfering an inflation of the airbag element 40 as shown in FIG. 3A and FIG. 3B. The trim unit 10 may further include at least one clamping element (not shown) to support the attachment of the trim unit 10 to the vehicle body portion 20.

FIG. 3A shows the trim assembly 1 in an initial mounting state. The guiding portion 11 includes a protrusion 12 formed at least partially at an inner surface of the through-hole 11. In other words, the protrusion 12 may at least partially extend in circumferential direction of the inner surface of the through-hole 11. The protrusion 12 is configured to support the head portion 33 of the shoulder screw 30, such that the shoulder screw 30 may be held inside the guiding portion 11 in place.

The head portion 33 of the shoulder screw 30 may include a flange 34, which has a bigger diameter than the shoulder portion 32, and/or an outer diameter of the head portion 33 may be bigger than that of the shoulder portion 32. Further, the diameter of the shoulder portion 32 is bigger than a diameter of the threaded portion 31 such that only the threaded portion 31 is screwed in the vehicle body portion 20 through the guiding portion 11 of the trim unit 10. Accordingly, the shoulder portion 32 defines a distance between the vehicle body portion 20 and the protrusion 12 of the guiding portion 11.

If the airbag element 40 is deployed as shown in FIG. 3B, the trim unit 10 pivots around the shoulder portion 32 of the shoulder screw 30. Accordingly, the trim unit 10 can be tilted away from the vehicle body portion 20 to provide a gap between the vehicle body portion 20 and the trim unit 10. The movement of the trim unit 10 may be limited by a bottom surface 13 of the guiding portion 11 at the head portion 33 of the fixing element 30. In other words, the bottom surface 13 of the guiding portion 11 is held by the head portion 33 such that the trim unit 10 does not fall off. A pivoting angle of the trim unit 10 may be adjusted to a shape of the vehicle body portion 20. As a result, the trim assembly 1 may provide a secure and safe deployment of the airbag element 40 without any damages such as cracks or fragments of the trim unit 10.

It has to be noted that embodiments of the disclosure are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the disclosure has been illustrated and described in detail in the drawings and description, such illustration and description are to be considered illustrative or exemplary and not restrictive. The disclosure is not limited to the disclosed embodiments. Other variations to the disclosed embodiments can be understood and effected by those skilled in the art in practicing a claimed disclosure, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

What is claimed is:

1. A trim assembly for deploying an airbag element, the trim assembly comprising:
a vehicle body portion,
a trim unit, and
at least one fixing element,
wherein the fixing element is configured to attach the trim unit to the vehicle body portion,
wherein the airbag element is arranged between the trim unit and the vehicle body portion,
wherein the trim unit is configured to cover at least partially the airbag element, and
wherein the trim unit is pivotable about the fixing element such that the trim unit is tilted away from the vehicle body portion during a deployment of the airbag element.

2. The trim assembly according to claim 1, wherein the trim unit comprises at least one guiding portion, the guiding portion being formed as a through-hole and configured to receive the fixing element.

3. The trim assembly according to claim 2, wherein the guiding portion comprises a protrusion formed at least partially at an inner surface of the through-hole, the protrusion being configured to hold the fixing element in place.

4. The trim assembly according to claim 3, wherein the fixing element comprises a head portion, a shoulder portion and a threaded portion, the shoulder portion connecting the head portion and the threaded portion, the shoulder portion having a bigger diameter than the threaded portion, only the threaded portion being screwed in the vehicle body portion through the trim unit.

5. The trim assembly according to claim 4, wherein the head portion has a bigger diameter than the shoulder portion, the head portion being held by the protrusion of the guiding portion.

6. The trim assembly according to claim 4, wherein the shoulder portion defines a distance between the vehicle body portion and the protrusion of the guiding portion.

7. The trim assembly according to claim 4, wherein the trim unit is pivotable around the shoulder portion of the fixing element.

8. The trim assembly according to claim 2, wherein the guiding portion is arranged on an opposite side relative to a deployment direction of the airbag element.

9. The trim assembly according to claim 1, wherein the trim unit comprises at least one clamping element.

10. The trim assembly according to claim 1, wherein the trim unit is an A-pillar, B-pillar, C-pillar and/or D-pillar and the airbag element comprises an inflatable curtain.

11. The trim assembly according to claim 1, wherein a pivoting angle of the trim unit is adaptable to a shape of the vehicle body portion.

12. A vehicle comprising the trim assembly according to claim 1.

13. A method for manufacturing a trim assembly, the method comprising the steps of:
attaching a trim unit to a vehicle body portion,
arranging an airbag element between the trim unit and the vehicle body portion, and
covering the airbag element at least partially by the trim unit, so that during a deployment of the airbag element, the trim unit is pivotable about a fixing element such that the trim unit is tilted away from the vehicle body portion.
